(19) United States
(12) Patent Application Publication
(10) Pub. No.: US 2006/0130646 A1
(43) Pub. Date: Jun. 22, 2006

(54) Dust-collecting apparatus and method for a vacuum cleaner

(75) Inventors: Ji-won Seo, Jeonju-si (KR); Jang-keun Oh, Gwangju-city (KR)

Correspondence Address: BLANK ROME LLP, 600 NEW HAMPSHIRE AVENUE, N.W., WASHINGTON, DC, 20037, US

(73) Assignee: SAMSUNG GWANGJU ELECTRONICS CO., LTD.

(21) Appl. No.: 11/203,990

(22) Filed: Aug. 16, 2005

(30) Foreign Application Priority Data
Dec. 22, 2004 (KR) 2004-110061

(51) Int. Cl. B01D 46/46

(52) U.S. Cl. 95/8

(57) ABSTRACT

A dust-collecting apparatus for a vacuum cleaner comprises a main body including an air inlet and an air outlet, a collection unit disposed at a lower part of the main body to store therein dust and moisture separated from dust-laden air, and one or more guide units disposed in an air passage in the main body to divert the course of the air.

This application claims benefit under 35 U.S.C. § 119a of Korean Patent Application No. 2004-110061, filed on Dec. 22, 2004, the entire contents of which is incorporated herein by reference.

### BACKGROUND OF THE INVENTION

1. Field of the Invention

The present invention relates to a vacuum cleaner. More particularly, the present invention relates to a dust-collecting apparatus for a vacuum cleaner, which separates dust and moisture from air drawn into the vacuum cleaner, and a method for making and using a dust-collecting apparatus.

2. Description of the Related Art

Conventional vacuum cleaners using a dust bag require inconveniently frequent replacement of the dust bag. Accordingly, a cyclone dust-collecting apparatus has been developed, which is semi-permanent, and is now widely used in place of apparatus including a dust bag.

Generally, the cyclone dust-collecting apparatus includes an air inlet on a circumference thereof, an air outlet at an upper part thereof and a dust receptacle at a lower part thereof, as disclosed in Korean Publication Patent No. 2001-0104810. Furthermore, for better dust-collecting efficiency, a dedicated grill may be prepared at the air outlet, as disclosed in Korean Publication Patent No. 2002-0075487.

The cyclone dust-collecting apparatus comprises an air passage connected to the air inlet, the dust receptacle and the grill. The intake air flows through this air passage. As the air passes through the air passage, dust and moisture in the air is separated and collected into the dust receptacle, and cleaned air from which the dust and moisture is separated is discharged from the dust-collecting apparatus through the air outlet. Therefore, the structure of the air passage affects the efficiency of separating the dust and moisture. That is, the design of the air passage becomes important in the dust-collecting apparatus.

However, even if the air passage has an optimum structure, the inventors have found that the amount of dust and moisture collected and the suction force varies depending on the surface being cleaned. Therefore, there is a need for improvements in air passage design.

### SUMMARY OF THE INVENTION

An aspect of the present invention is to solve at least the above problems and/or disadvantages and to provide at least the advantages described below. Accordingly, in some embodiments, a dust-collecting apparatus has an air passage that can change according to a state of air flowing therein.

Further embodiments of the present invention provide a dust-collecting apparatus improved in efficiency of separating dust and moisture.

In order to achieve the above-described aspects of the present invention, in an embodiment, a dust-collecting apparatus for a vacuum cleaner comprises a main body including an air inlet and an air outlet, a collection unit disposed at a lower part of the main body to store dust and moisture separated from dust-laden air, and one or more guide units disposed in an air passage in the main body to divert the course of the air.

In an exemplary embodiment, the guide unit comprises at least one rotatable guide plate. In an embodiment, the guide unit comprises first and second guide plates for diverting the course of the air, and first and second knobs connected to one ends of the first and the second guide plates.

The main body comprises a separation unit having the air inlet therein, and a cover unit having the air outlet therein.

The dust-collecting apparatus may further comprise a control unit for automatically adjusting the mounting angles of the guide plates to enhance efficiency of separating the dust and moisture.

The control unit comprises a sensor part for measuring a dust amount, humidity and suction pressure; a calculation part for calculating proper mounting angles of the guide plates based on the measured dust amount, the humidity and the suction pressure; and a driving part for rotating the guide plates by the calculated mounting angles.

The sensor part comprises a dust sensor, a Humidity sensor and a pressure sensor.

In order to achieve another aspect of the present invention, there is provided a method for separating dust and moisture in a vacuum cleaner, the method comprising the steps of, a) drawing air including dust and moisture in through an air inlet; b) selecting an optimum air passage in a separation unit; c) separating from the air and collecting into a collection unit the dust and moisture while the air passes through the optimum air passage; d) separating and collecting remaining dust and moisture which was not initially separated by the separation unit; and e) discharging the air from which the dust and moisture is removed to the outside of the dust-collecting apparatus through a second outlet and an air outlet.

In an embodiment, step b) comprises the further steps of: f) measuring an amount of dust in the intake air, the humidity of the air, and the suction pressure of the vacuum cleaner using sensors; g) calculating desired angle positions of first and second guide plates for configuration of the optimum air passage; and h) rotating the first and the second guide plates into position using an actuator.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of a dust-collecting apparatus according to an embodiment of the present invention;

FIG. 2 is an exploded, perspective view of the dust-collecting apparatus of FIG. 1;

FIG. 3 is a plane view of a separation unit of FIG. 2;

FIG. 4 is a sectional view of FIG. 1, cut along a line IV-IV;

FIG. 5 is a view showing first and second guide plates of FIG. 4 as rotated;

FIG. 6 is a sectional view of FIG. 1, cut along a line VI-VI;

FIG. 7 is a block diagram illustrating a control unit according to an embodiment of the present invention; and

FIG. 8 is a flowchart illustrating a dust-collecting method according to an embodiment of the present invention.

### DETAILED DESCRIPTION OF THE EXEMPLARY EMBODIMENTS

Hereinafter, an embodiment of the present invention will be described in detail with reference to the accompanying drawing figures.

In the following description, the same drawing reference numerals may be used for the same elements even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

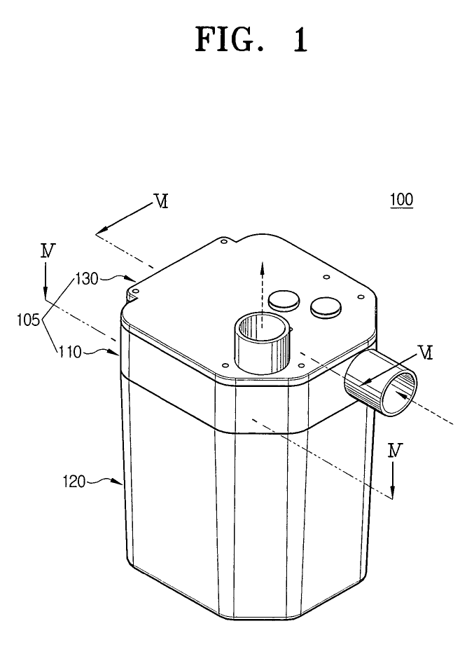

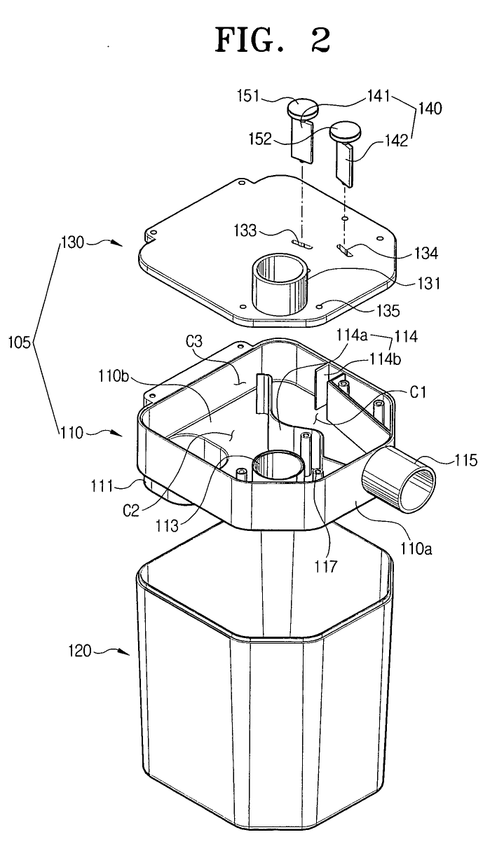

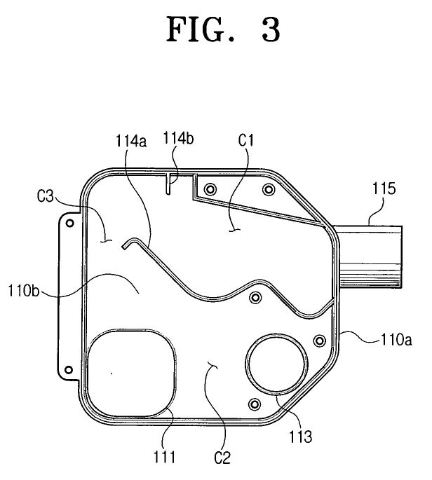

Referring to FIGS. 1 and 2, a dust-collecting apparatus 100 comprises a main body 105 which includes a separation unit 110 and a cover unit 130, a collection unit 120 and a guide unit 140. A dotted arrow in FIG. 1 refers to flow of air.

The separation unit 110 separates dust and moisture from intake air while the air passes through the air passage formed therein. The air including dust and moisture may be referred to herein as ‘dust-laden air.’ The separation unit 110 comprises an air inlet 115, a first outlet 111, a guide wall 114, and a second outlet 113.

The air inlet 115 is formed on a sidewall 110a of the separation unit 110 to draw the dust-laden air into the separation unit 110. The air inlet 115 is formed as a pipe having a circular section and disposed on the sidewall 110a of the separation unit 110 by adhesion or by welding so as to protrude by a certain length. However, the air inlet 115 may be integrally formed with the separation unit 110 by molding; furthermore, the air inlet 115 can be constructed with various configurations such as having a rectangular or triangular section.

The first outlet 111 is disposed on a bottom 110b of the separation unit 110 to offer fluid connection between the separation unit 110 and the collection unit 120. The first outlet 111 is formed as a pipe having an oval section and disposed on the bottom 110b of the separation unit 110 by adhesion or by welding so as to protrude into the collection unit 120 by a certain length. Also, the first outlet 111 may be integrally formed with the separation unit 110 by molding and can have a cross-section of any desired shape. For example, the cross-section may be a circle, rectangle, or triangle.

Through the first outlet 111, the dust and moisture being separated as the air passes through the air passage within the separation unit 110 is drawn into the collection unit 120. Additionally, cleaned air from which the dust and moisture has been separated and air still including the dust and moisture may flow in. Such processes may happen simultaneously or at certain time intervals.

The guide wall 114 guides the dust-laden air drawn in through the air inlet 115 to the first outlet 111. The guide wall 114 comprises first and second guide walls 114a and 114b. Although the present embodiment adopts two guide walls 114a and 114b, more guide walls can be employed if necessary.

The first guide wall 114a is a curved wall formed in contact with the bottom 110b and the sidewall 110a of the separation unit 110. The first guide wall 114a divides an inner space of the separation unit 110 into a first chamber C1 fluidly communicated with the air inlet 115 and a second chamber C2 fluidly communicated with the first outlet 111. The first and the second chambers C1 and C2 are connected in fluid communication with each other through a connection path C3 formed between the first guide wall 114a and the sidewall 110a. The second guide wall 114b is a straight wall formed in contact with the bottom 110b and the sidewall 110a of the separation unit 110.

The air passage is fixedly formed in the separation unit 110, being defined by the air inlet 115, the first outlet 111, the first and the second guide walls 114a and 114b and the sidewall 110a. The air drawn in through the air inlet 115 passes through the connection path C3 along the above-formed air passage and flows into the collection unit 120 through the first outlet 111.

In an exemplary embodiment, the dust and moisture included in the air is separated from the air by friction and collision of the air with the first guide wall 114a, the second guide wall 114b and the sidewall 110a because the friction and collision diverts the course of the air and thereby reduces speed of the airflow so that the air cannot carry its load of dust and moisture.

The second outlet 113 is disposed on the bottom 110b of the separation unit 110 to connect the collection unit 120 and an air outlet 131 in fluid communication with each other. The second outlet 113 may be formed as a pipe having a circular section and disposed on the bottom 110b of the separation unit 110 by adhesion or by welding to protrude toward the cover unit 130. However, the second outlet 113 may be integrally formed with the separation unit 110 by molding and may have other various sectional shapes such as an oval, square and triangle. The second outlet 113 may be further provided with a filter or a grill for preventing backflow of dust and moisture in the separation unit 110.

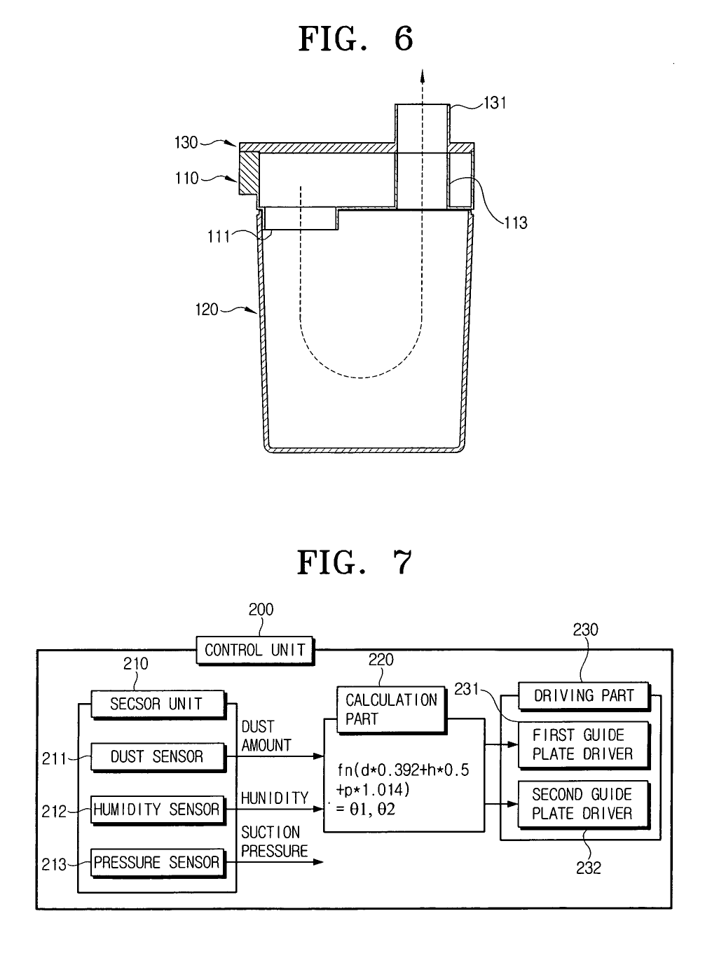

The collection unit 120 is formed as a square receptacle, being chamfered at one side, for collecting therein the dust and moisture. The collection unit 120 is detachably mounted to a lower part of the separation unit 110. The dust and moisture included in the air drawn in through the first outlet 111 is deposited on the bottom of the collection unit 120. Referring to FIG. 6, the cleaned air is discharged from the collection unit 120 through the second outlet 113. Meanwhile, separation of the dust and moisture can be performed in the collection unit 120. The principle of the separation will not be described again since it is the same as applied in the separation unit 110.

In the embodiment shown, the cover unit 130 is a square cover, chamfered at one side, and connected to an upper part of the separation unit 110 to seal the air passage formed in the separation unit 110. The cover unit 130 is attached to the separation unit 110 using screws or other suitable fasteners. To this end, the cover unit 130 includes screw holes 135 while the separation unit 110 includes taps 117. However, the cover unit 130 and the separation unit 110 can be connected in other ways besides the use of screws; for example, the cover unit 130 may be fit into the separation unit 110.

Referring to FIGS. 2 and 6, the cover unit 130 has the air outlet 131 formed on a top side thereof and connected to the second outlet 113. The air outlet 131 is formed as a pipe having a circular section and disposed on the top side of the cover unit 130 by adhesion or by welding to protrude outward. Also, the air outlet 131 and the cover unit 130 may be integrally formed by molding, and the air outlet 131 may have other sectional shapes such as oval, square and triangle.

Referring to FIG. 2, the guide unit 140 diverts the air passage, which is a path of the airflow, within the separation unit 110. For this purpose, the guide unit 140 comprises first and second guide plates 141 and 142. If necessary, more guide plates besides the two guide plates 141 and 142 can be further provided.

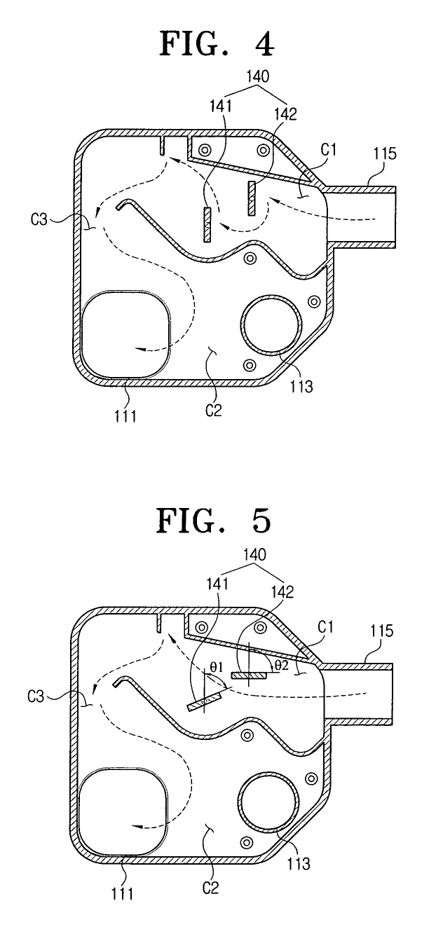

Referring to FIGS. 2, 4 and 5, the first guide plate 141 is formed as a substantially rectangular rib rotatably mounted to the cover unit 130 and disposed in the air passage within the first chamber C1. As the first guide plate 141 rotates by an angle θ1 with respect to a vertical direction in FIG. 5, the air passage of the separation unit 110 is diverted.

In order to mount the first guide plate 141 to the cover unit 130, a first slit 133 is provided to the cover unit 130. The first slit 133 is formed as a substantially rectangular hole formed on the top side of the cover unit 130 for the first plate 130 to penetrate. A first knob 151 fixes the first guide plate 141 to the cover unit 130. The first knob 151 frictionally contacts with the top side of the cover unit 130 so as to fix the first guide plate 141 in a position as adjusted.

Referring to FIGS. 2, 4 and 5, the second guide plate 142 is formed as a substantially rectangular rib rotatably mounted to the cover unit 130 and disposed in the air passage within the first chamber C1. As the second guide plate 142 rotates by an angle θ2 with respect to a vertical direction in FIG. 5, the air passage of the separation unit 110 is diverted.

In order to mount the second guide plate 142 to the cover unit 130, a second slit 134 is provided to the cover unit 130. The second slit 134 is formed as a substantially rectangular hole formed on the top side of the cover unit 130 for the second plate 130 to penetrate. A second knob 152 fixes the second guide plate 142 to the cover unit 130. The second knob 152 frictionally contacts with the top side of the cover unit 130 so as to fix the second guide plate 142 in a position as adjusted.

The first and the second guide plates 141 and 142 can be disposed in the second chamber C2 rather than the first chamber C1. Or, the second chamber C2 may have either of the first and the second guide plates 141 and 142. That is, the first and the second guide plates 141 and 142 can be arranged in various manners.

The air passage in the separation unit 110 can be varied by repositioning the first and second guide plates 141 and 142 respectively. For example, an air passage as shown in FIG. 4 may be changed to another form as shown in FIG. 5. Accordingly, flow of the air along the air passage illustrated by the dotted arrows is diverted. For reference, only a few arrows are shown to represent the air flow for concise illustration.

Consequently, by existence of the first and the second guide plates 141 and 142, the air passage can be varied for optimum performance of separation of the dust and moisture, according to conditions of the surface being cleaned.

It is difficult for a user to manually adjust the mounting angle of the first and second guide plates 141 and 142 according to the conditions of the surface being cleaned, since the user has to personally check the state of the surface being cleaned, find the best mounting angles of the first and second guide plates 141 and 142 and rotate plates 141 and 142 according to the found angles.

In order to overcome the above problem, the dust-collecting apparatus 100 comprises a control unit 200 for automatically adjusting the mounting angles of the first and the second guide plates 141 and 142, as shown in FIG. 6. Since the invention encompasses various detailed connection structures between the control unit 200 and the first and the second guide plates 141 and 142, a description of these structures will be omitted.

The control unit 200 comprises a sensor part 210, a calculation part 220 and a driving part 230.

The sensor part 210 measures an amount ‘d’ of the dust included in air drawn in through the air inlet 115, a humidity ‘h’ of the dust-laden air and a suction pressure ‘p’ of a vacuum cleaner (not shown). Therefore, the sensor 210 includes a dust sensor 211, a humidity sensor 212 and a pressure sensor 213 which are mounted in one side of the air inlet 115 for precise measurement.

The calculation part 220 calculates mounting angles of the first and the second guide plates 141 and 142 for formation of an optimum air passage based on the dust amount, humidity and suction pressure measured by the sensor part 210. For this, the calculation part 220 uses an equation as follows:
fn(d×0.392+h×0.5+p×1.014)=θ1, θ2

wherein, fn(d×0.392+h×0.5+p×1.014) refers to a function for calculating the mounting angle as experimentally obtained, θ1 refers to the mounting angle of the first guide plate 141 and θ2 refers to the mounting angle of the second guide plate 142.

The driving part 230 rotates the first and the second guide plates 141 and 142 by the mounting angles θ1 and θ2 calculated by the calculation part 220. To this end, the driving part 230 comprises a first guide plate driver 231 and a second guide plate driver 232 for operating the first and the second guide plates 141 and 142, respectively.

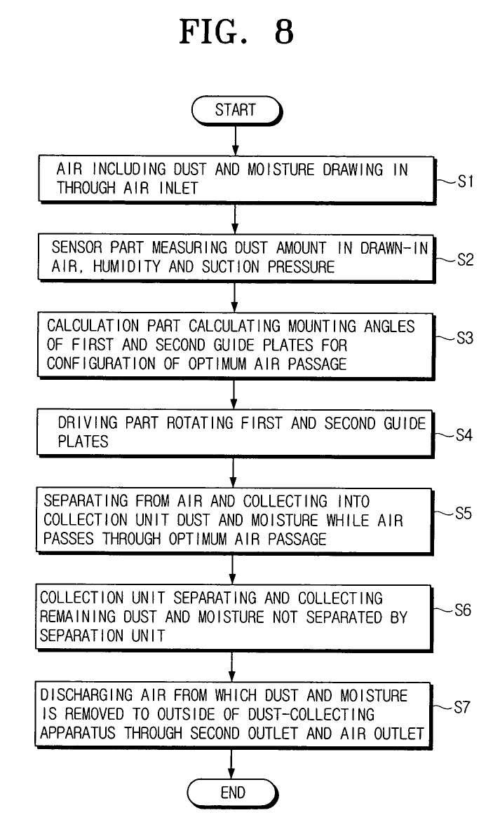

Hereinbelow, the operation of the dust-collecting apparatus 100 according to an embodiment of the present invention will be described with reference to FIGS. 2, 4 and 8.

As the vacuum cleaner (not shown) is driven, a suction pressure is generated, and accordingly, the dust-laden air is drawn in through the air inlet 115 formed on the sidewall 110a of the separation unit 110 (S1).

The sensor part 210 measures the amount of dust included in the intake air, the humidity of the dust-laden air and the suction pressure of the vacuum cleaner using the dust sensor 211, the humidity sensor 212 and the pressure sensor 213 (S2).

The calculation part 220 calculates the mounting angles of the first and the second guide plates 141 and 142 to configure the air passage for optimum performance in separating dust and moisture, based on the measured dust amount, the humidity and the suction pressure (S3).

The driving part 230 rotates the first and the second guide plates 141 and 142 according to the calculated mounting angles (S4).

As described above, by adjusting the angles of the first and the second guide plates 141 and 142, the air passage in the separation unit 110 can be formed to ensure optimum separation performance. As the dust-laden air passes through the thus-configured air passage, the dust and moisture in the air is separated and collected in the collection unit 120 through the first outlet 111.

In addition, the dust and moisture which is not separated by the separation unit 110 can be secondarily separated and collected in the collection unit 120 (S6).

Then, the cleaned air is discharged to the outside of the dust-collecting apparatus 100 through the second outlet 113 and the air outlet 131 (S7).

According to an embodiment of the present invention, since the air passage can be varied according to the state of the intake air, the efficiency of separating dust and moisture can be enhanced.

Further, the filter is prevented from being clogged by moisture, and as a result, a constant suction pressure can be maintained.

Moreover, the vacuum cleaner according to the present invention is able to offer hygienic circumstance by preventing mold and bacteria from breeding at the filter.

While the invention has been shown and described with reference to certain embodiments thereof, it will be understood by those skilled in the art that various changes in form and details may be made therein without departing from the spirit and scope of the invention as defined by the appended claims.

What is claimed is:

1. A dust-collecting apparatus for a vacuum cleaner, comprising:
a main body including an air inlet and an air outlet;
a collection unit disposed at a lower part of the main body to store therein dust and moisture separated from dust-laden air; and
one or more movable guide units disposed in an air passage in the main body to divert the course of the air.

2. The dust-collecting apparatus of claim 1, wherein the guide unit comprises at least one guide plate which is rotatable.

3. The dust-collecting apparatus of claim 2, wherein the guide unit comprises first and second guide plates for diverting the course of the air, and first and second knobs connected respectively to ends of the first and second guide plates.

4. The dust-collecting apparatus of claim 2, wherein the main body comprises a separation unit having the air inlet therein, and a cover unit having the air outlet therein.

5. The dust-collecting apparatus of claim 4, wherein the separation unit comprises:
a first outlet in fluid connection with the collection unit; and
a second outlet in fluid connection between the separation unit and the collection unit.

6. The dust-collecting apparatus of claim 4, wherein the separation unit comprises first and second guide walls for dividing an inner space of the separation unit into a first chamber in fluid connection with the air inlet and a second chamber in fluid connection with the first outlet.

7. The dust-collecting apparatus of claim 4, further comprising a control unit for automatically adjusting an angular position of the first and second guide plates to enhance efficiency of separating the dust and moisture.

8. The dust-collecting apparatus of claim 7, wherein the control unit comprises:
a sensor part for measuring a dust amount, humidity and suction pressure;
a calculation part for calculating desired angular positions of the guide plates based on the measured dust amount, the humidity and the suction pressure; and
a driving part for rotating the guide plates to the desired angular positions.

9. The dust-collecting apparatus of claim 8, wherein the sensor part comprises a dust sensor, a humidity sensor and a pressure sensor.

10. A method for separating dust and moisture in a vacuum cleaner, the method comprising the steps of:
a) drawing air including dust and moisture in through an air inlet;
b) forming an optimum air passage in a separation unit under control of a control unit;
c) separating the dust and moisture from the air and collecting the dust and moisture into a collection unit while the air passes through the optimum air passage;
d) using the collection unit, separating and collecting remaining dust and moisture which was not separated by the separation unit; and
e) discharging treated air to the outside of the dust-collecting apparatus through a second outlet and an air outlet.

11. The method of claim 10, wherein step b) comprises the further steps of:
i) measuring an amount of dust and humidity of the intake air and suction pressure of the vacuum cleaner;
g) calculating angular positions of first and second guide plates for configuration of the optimum air passage; and
h) rotating the first and the second guide plates into the desired angular positions.
